(19) United States
(12) Patent Application Publication
(10) Pub. No.: US 2004/0140166 A1
(43) Pub. Date: Jul. 22, 2004

(54) Integral rotor and tone wheel

(75) Inventors: Richard C. Brown, Howell, MI (US); Kwok K. Wan, Rochester, MI (US)

Correspondence Address: SCOTT A. MCBAIN, DELPHI TECHNOLOGIES, INC., Legal Staff Mail Code: 480-410-202, P.O. BOX 5052, Troy, MI, 48007, US

(73) Assignee: DELPHI TECHNOLOGIES INC.

(21) Appl. No.: 10/348,128

(22) Filed: Jan. 21, 2003

(51) Int. Cl. F16D 65/12

(52) U.S. Cl. 188/218 XL

(57) ABSTRACT

A ferromagnetic brake rotor having an integral tone ring is provided. A sensor is positioned adjacent to the rotor for sensing magnetic property variations in the ferromagnetic brake rotor. Magnetic property variations in a ferromagnetic brake rotor disc are sensed. Rotational properties for a wheel attached to the ferromagnetic brake rotor disc are determined based on the magnetic property variations. A brake system is then modulated based on to the rotational properties the wheel.

### TECHNICAL FIELD OF THE INVENTION

This invention relates to vehicle brake systems, and more particularly to provisions for sensing the rotational velocity of a vehicle brake rotor disc.

### BACKGROUND OF THE INVENTION

Vehicles such as automobiles, motorcycles, trucks, buses, and motor homes typically include a hydraulic brake system. Many vehicles are additionally equipped with anti-lock hydraulic braking systems (ABS). ABS systems generally incorporate speed-sensing systems and feedback control systems that operate together to provide controlled modulated vehicle braking under certain conditions. Various ABS systems have found application in automobiles, trucks, buses and other vehicles such as motorcycles. A motorcycle in particular has specific requirements for an ABS system that an automobile does not. Generally, the rotor disc of a motorcycle is exposed and the brake rotor may even be an essential element of the overall aesthetic design of the motorcycle.

ABS systems are generally quite bulky, and much effort has been applied to reducing the bulk of the various ABS components. The small size of a motorcycle presents a unique challenge since the additional weight and power consumption of an ABS may affect the motorcycle performance. However, with motorcycle ABS systems there are limited options for implementing a wheel speed sensing system, and a tone ring assembly is usually bolted to the brake rotor. It is desirable to keep the moving mass of a motorcycle wheel to a minimum. Therefore, the additional mass of the tone ring assembly bolted to a brake rotor is undesirable. Therefore, it would be desirable to provide an improved brake rotor system that overcomes these and other disadvantages.

### SUMMARY OF THE INVENTION

A ferromagnetic brake rotor having an integral tone ring is provided. A sensor is positioned adjacent to the rotor for sensing magnetic property variations in the ferromagnetic brake rotor.

In accordance with another aspect of the invention, a method is directed to operating vehicle antilock brakes by sensing magnetic property variations in a ferromagnetic brake rotor disc, determining rotational properties for a wheel attached to the ferromagnetic brake rotor disc based on the magnetic property variations, and modulating a brake system responsive to determining the rotational properties of the wheel.

In accordance with yet another aspect of the invention, a vehicle including a ferromagnetic brake rotor having an integral tone ring is provided. A sensor is positioned adjacent to the integral tone ring for sensing magnetic property variations as the rotor rotates.

The foregoing and other features and advantages of our invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram of a ferromagnetic brake rotor having an integral tone ring in accordance with the invention.

FIG. 2 is a side profile of a brake rotor as in FIG. 1.

FIG. 3 is another side profile of a brake rotor in accordance with the invention.

FIG. 4 is yet another side profile of a brake rotor in accordance with the invention FIG. 5 is a flow diagram of a process for operating vehicle antilock brakes by sensing magnetic property variations in a ferromagnetic brake rotor disc.

### DETAILED DESCRIPTION OF THE PRESENTLY PREFERRED EMBODIMENTS

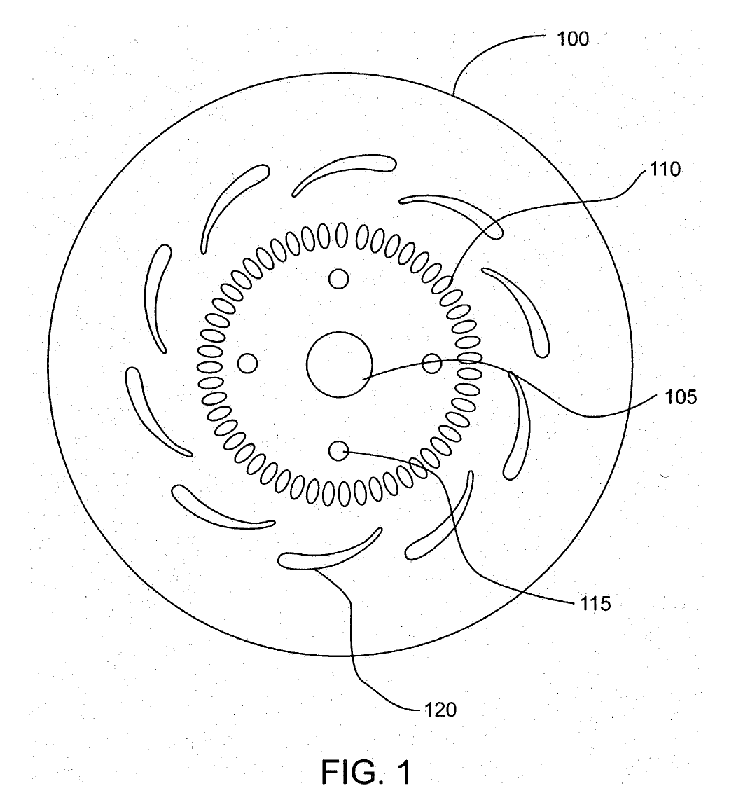

FIG. 1 is a diagram of a brake rotor having an integral tone ring in accordance with the invention. FIG. 1 shows a ferromagnetic brake rotor disc 100. The brake rotor disc 100 is shown having a center hole 105, an integral tone ring 110, mounting holes 115 and optional thermal expansion slots 120.

The brake disc rotor 100 (hereinafter rotor) is comprised of a ferromagnetic material such as magnetic stainless steel or another ferromagnetic alloy with a hardness commensurate with the specific brake system parameters. The rotor 100 may be any diameter suitable for a vehicle brake system. The rotor 100 is typically mounted on a brake assembly (not shown) or a wheel (not shown) using the mounting holes 115. FIG. 1 illustrates an embodiment of the invention having four mounting holes 115. However, the rotor 100 may have any number of mounting holes sufficient for coupling The rotor 100 to a brake assembly or a wheel. The center hole 105 may be any diameter that does not interfere with the function of the rotor or attachment to a brake assembly. Typically, the size of the center hole 105 is selected for aesthetic purposes. Expansion slots 120 are optional. The expansion slots 120 provide for thermal expansion when the brake rotor 100 becomes heated under use. The expansion slots may have a variety of shapes and forms as will be recognized by the skilled practitioner.

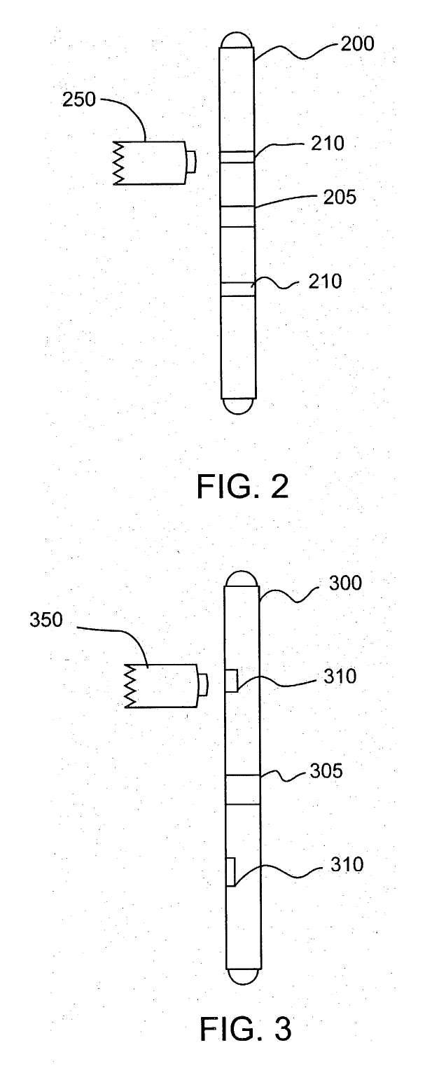

In FIG. 1, the tone ring 110 is shown as a series of through-hole slots in a radial pattern concentric with the rotor 100 circumference. However, the tone ring may have several configurations as will be further elaborated in FIGS. 2, 3 and 4. The tone ring 110 slots provide a consistent periodic variation in the magnetic characteristics of the rotor 100 that may-be sensed by a fixed magnetic pickup (not shown) positioned adjacent to the tone ring 110. The size, spacing and shape of the tone ring 110 slots are dictated by the type of magnetic sensor used. Generally, the tone ring 110 slots are sized, shaped and spaced to optimize the magnetic sensor performance in the application. In one embodiment the through-holes are ovoid. The magnetic sensor detects the magnetic variations arising from the tone ring as the rotor 100 rotates with a brake assembly or wheel. The tone ring 110 is generally placed in a thermally stable region of the rotor disc 100 inside the diameter of any thermal expansion slots, and does not provide relief of thermal stresses.

FIG. 2 is a side profile of a brake rotor as in FIG. 1. FIG. 2 shows a brake rotor 200 comprising a center hole 205 and a tone ring 210. A magnetic sensor 250 is shown positioned adjacent to the tone ring 210 of the rotor 200. The tone ring 210 comprises a series of radial through-hole slots concentric with the center hole 205 as in rotor 100 of FIG. 1. In one embodiment (not shown), the tone ring through-hole slots are filled with a non-metallic material such as a resin, a thermoplastic and the like. The filler material provides a smooth surface to the rotor, and prevents the accumulation of dirt and debris that might affect sensor performance. The magnetic sensor 250 may be an active or passive pickup device. The magnetic sensor 250 is generally connected to an ABS system that is able to interpret the sensor output.

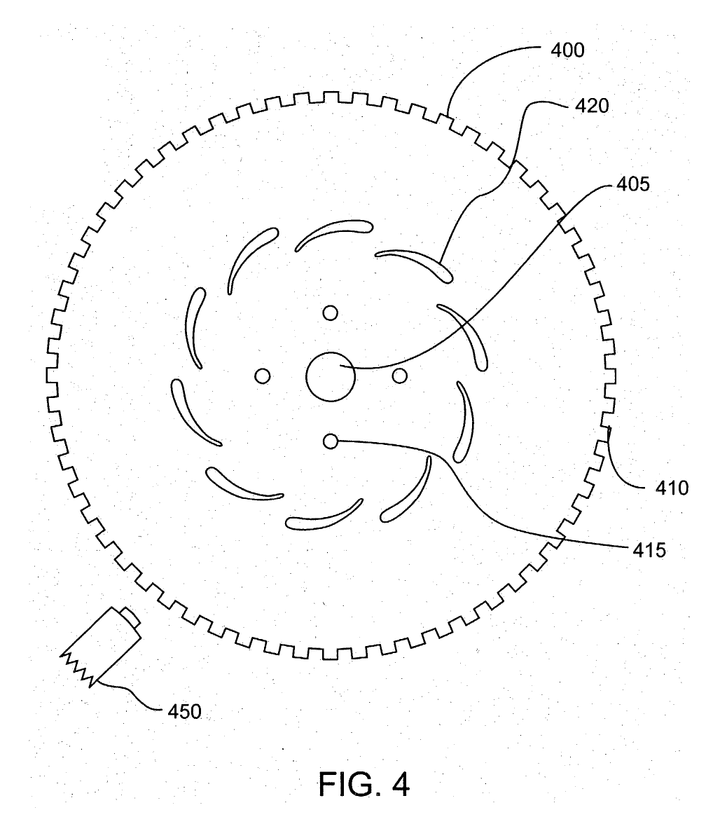

FIG. 3 is another side profile of a brake rotor in accordance with the invention. FIG. 3 again shows a brake rotor 300 comprising a center hole 305 and a tone ring 310. A magnetic sensor 350 is again shown positioned adjacent to the tone ring 310 of the rotor 300. The tone ring 310 of FIG. 3 is comprised of depressions in the surface of the rotor 300 instead of through holes as depicted in FIGS. 1 and 2. The tone ring 310 depressions may be ovoid, or rectangular and may have a constant or varying cross-sectional depth. In one embodiment, the depression is a vee-shaped groove oriented inline with the center of the rotor disc 300. In another embodiment the tone ring 310 depressions are filled with a non-magnetic material.

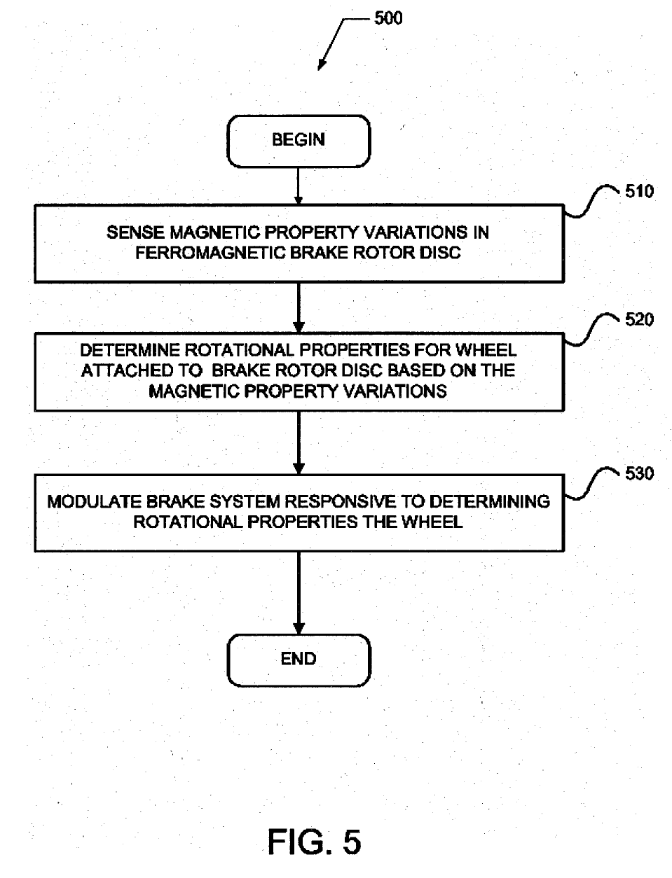

FIG. 4 is a diagram of a brake rotor having an integral tone ring in accordance with another embodiment of the invention. FIG. 4 shows a ferromagnetic brake rotor disc 400 having two surfaces. The brake rotor disc 400 is shown having a center hole 405, an integral tone ring 410, mounting holes 415 and optional thermal expansion slots 420. In FIG. 4, the tone ring 410 is shown comprising spaced notches distributed at intervals around the outer circumference of the rotor disc 400 from the first rotor surface to the second rotor surface. A magnetic sensor 450 is shown in FIG. 4 adjacent to the outer circumference of the rotor disc 400. In one embodiment, the notches are filled with a non-magnetic material. The notches may be square or rounded, and are generally spaced and sized to optimize the magnetic sensor performance. In another embodiment the notches are shaped to provide a unique aesthetic appearance. In one embodiment, the notches are vee-shaped, proving a “saw-blade” like appearance. The various configurations for the tone ring placement allow for specific aesthetic objective to be implemented, that are particularly applicable to modern motorcycle design of the “cruiser.”

FIG. 5 is a flow diagram of a process for operating vehicle antilock brakes by sensing magnetic property variations in a ferromagnetic brake rotor disc. Process 500 begins in step 510. In step 510, magnetic property variations in a ferromagnetic rotor disc are sensed. The magnetic property variations are generally sensed by a magnetic sensor 250 positioned adjacent to the rotor disc 200. The magnetic sensor 250 detects the variations in magnetic fielded due to the tone ring 210 rotating in proximity to the sensor 250. The magnetic property variations of the rotor 200 may be detected at any time while the rotor is rotating.

In step 520, rotational properties for a wheel attached to a ferromagnetic brake rotor disc are determined based on the magnetic property variations sensed in step 510. The magnetic sensor 250 is generally coupled to an ABS controller that interprets the magnetic property variations and determines parameters such as the angular velocity of the wheel. ABS controllers are known to those skilled in the art and will not be discussed further. The rotational properties of the wheel may be determined at any time after the magnetic property variations are detected in step 510.

In step 530, a brake system is modulated responsive to determining the rotational properties of the wheel in step 520. The ABS controller is generally coupled to a hydraulic brake booster and calipers. The ABS controller modulates the brake calipers based on the rotational properties of the wheel determined in step 520. The brake system may be modulated at any time after the rotational properties of the wheel are determined.

The scope of the invention is indicated in the appended claims. We intend that all changes or modifications within the meaning and range of equivalents are embraced by the claims.

We claim:

1. An apparatus for a vehicle antilock brake system comprising:
a ferromagnetic brake rotor having an integral tone ring wherein a sensor is positioned adjacent to the integral tone ring for sensing magnetic property variations as the rotor rotates.

2. The apparatus of claim 1 wherein the brake rotor comprises:
a rotor disc having a first rotor surface and a second rotor surface wherein the first rotor surface and the second rotor surface are opposing faces of the rotor disc and wherein the tone ring comprises through-holes from the first rotor surface to the second rotor surface distributed at intervals in a radial pattern concentric to a center of the rotor disc.

3. The apparatus of claim 2 wherein the through-holes are substantially oval.

4. The apparatus of claim 2 wherein the through-holes are filled with a non-metallic filler.

5. The apparatus of claim 1 wherein the brake rotor comprises a rotor disc having a first rotor surface and a second rotor surface wherein the first rotor surface and the second rotor surface are opposing faces of the rotor disc and wherein the tone ring comprises depressions in the first rotor surface distributed at intervals in a radial pattern concentric to a center of the rotor disc.

6. The apparatus of claim 5 wherein the depressions are substantially oval.

7. The apparatus of claim 5 wherein the depressions are filled with a non metallic filler.

8. The apparatus of claim 1 wherein the brake rotor comprises:
a rotor disc having a first rotor surface and a second rotor surface wherein the first rotor surface and the second rotor surface are opposing faces of the rotor disc and wherein the tone ring comprises spaced notches distributed at intervals around the outer circumference of the rotor disc from the first rotor surface to the second rotor surface.

9. The apparatus of claim 8 wherein the notches are filled with a non-metallic filler.

10. A vehicle including:
a ferromagnetic brake rotor having an integral tone ring wherein a sensor is positioned adjacent to the integral tone ring for sensing magnetic property variations as the rotor rotates.

11. The vehicle of claim 10 wherein the brake rotor comprises:
a rotor disc having a first rotor surface and a second rotor surface wherein the first rotor surface and the second rotor surface are opposing faces of the rotor disc and wherein the tone ring comprises through-holes from the first rotor surface to the second rotor surface distributed at intervals in a radial pattern concentric to a center of the rotor disc.

12. The vehicle of claim 11 wherein the through-holes are substantially oval.

13. The vehicle of claim 111 wherein the through-holes are filled with a non-metallic filler.

14. The vehicle of claim 111 wherein the brake rotor comprises a rotor disc having a first rotor surface and a second rotor surface wherein the first rotor surface and the second rotor surface are opposing faces of the rotor disc and wherein the tone ring comprises depressions in the first rotor surface distributed at intervals in a radial pattern concentric to a center of the rotor disc.

15. The vehicle of claim 14 wherein the depressions are substantially oval.

16. The vehicle of claim 14 wherein the depressions are filled with a non-metallic filler.

17. The vehicle of claim 10 wherein the brake rotor comprises:
a rotor disc having a first rotor surface and a second rotor surface wherein the first rotor surface and the second rotor surface are opposing faces of the rotor disc and wherein the tone ring comprises spaced notches distributed at intervals around the outer circumference of the rotor disc from the first rotor surface to the second rotor surface.

18. The apparatus of claim 17 wherein the notches are filled with a non metallic filler.

19. A method for operating vehicle antilock brakes comprising:
sensing magnetic property variations in a ferromagnetic brake rotor disc;
determining rotational properties for a wheel attached to the ferromagnetic brake rotor disc based on the magnetic property variations; and
modulating a brake system responsive to determining the rotational properties the wheel.

20. A system for vehicle antilock brakes comprising:
means for sensing magnetic property variations in a ferromagnetic brake rotor disc;
means for determining rotational properties for a wheel attached to the ferromagnetic brake rotor disc based on the magnetic property variations; and
means for modulating a brake system responsive to determining the rotational properties the wheel.
